(19) United States
(12) Patent Application Publication
(10) Pub. No.: US 2018/0121199 A1
(43) Pub. Date: May 3, 2018

(54) Fused Multiply-Add that Accepts Sources at a First Precision and Generates Results at a Second Precision

(71) Applicant: Apple Inc., Cupertino, CA (US)

(72) Inventors: Tal Uliel, Herzeliya Pituah (IL); Jeffry E. Gonion, Campbell, CA (US); Ali Sazegari, Los Altos, CA (US); Eric Bainville, Sunnyvale, CA (US)

(21) Appl. No.: 15/629,126

(22) Filed: Jun. 21, 2017

Related U.S. Application Data
(60) Provisional application No. 62/413,650, filed on Oct. 27, 2016.

(51) Int. Cl. G06F 9/30; G06F 7/483; G06F 7/485; G06F 7/487; G06F 7/544

(52) U.S. Cl. CPC G06F 9/30036; G06F 7/483; G06F 9/30014; G06F 7/4876; G06F 7/5443; G06F 7/485

(57) ABSTRACT

In an embodiment, a processor may implement a fused multiply-add (FMA) instruction that accepts vector operands having vector elements with a first precision, and performing both the multiply and add operations at a higher precision. The add portion of the operation may add adjacent pairs of multiplication results from the multiply portion of the operation, which may allow the result to be stored in a vector register of the same overall length as the input vector registers but with fewer, higher precision vector elements, in an embodiment. Additionally, the overall operation may have high accuracy because of the higher precision throughout the operation.

This application claims benefit of priority to U.S. Provisional Patent Application No. 62/413,650, filed on Oct. 27, 2016. The above application is incorporated herein by reference in its entirety.

### BACKGROUND

### Technical Field

Embodiments described herein are related to the field of processors and, more particularly, to vector floating point operations.

### Description of the Related Art

Fused multiply-add (FMA) is an important operation in signal processing, mathematics, and other fields in which precision of the results is critical. The FMA operation allows two numbers to be multiplied together, producing a result with more precision than the original input operand's precision, and then sums the result with a previous result before truncating precision to the result size (i.e. the same size as the input precision). This technique preserves some precision by avoiding the multiple stages of truncation that would occur using separate multiply and add operations. With vector FMA operations, multiple FMA operations can be performed in parallel on elements of the vector.

The use of lower precision (e.g. 16-bit) floating-point (FP) numbers in vector FMA operations generally allows throughput of vector code to be increased, but the lower precision format cannot express large numbers accurately. This property permits only limited amounts of accumulation before the accumulated result loses accuracy. Typically, in such situations, multiple instructions are used to: perform a lower precision multiply; convert the result to a higher precision (e.g. 32-bit FP); and accumulate in the higher precision. Such a solution loses the functionality of the fused multiply-add and also still incurs the loss of accuracy in the initial low-precision multiplication, although more accumulation can be supported.

### SUMMARY

In an embodiment, a processor may implement an FMA instruction that accepts vector operands having vector elements with a first precision, and performing both the multiply and add operations at a higher precision. The add portion of the operation may add adjacent pairs of multiplication results from the multiply portion of the operation, which may allow the result to be stored in a vector register of the same overall length as the input vector registers but fewer, higher precision vector elements, in an embodiment. Additionally, the overall operation may have high accuracy because of the higher precision throughout the operation.

### BRIEF DESCRIPTION OF THE DRAWINGS

The following detailed description makes reference to the accompanying drawings, which are now briefly described.

FIG. 1 is a block diagram of one embodiment of a computer system.

FIG. 2 is a block diagram of one embodiment of a vector execution unit.

FIG. 3 is a block diagram illustrating operation of one embodiment of the disclosed FMA instruction.

FIG. 4 is a flow chart illustrating operation of one embodiment of a processor to execute the disclosed FMA instruction.

FIG. 5 is a block diagram of one embodiment of a computer accessible storage medium.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “clock circuit configured to generate an output clock signal” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible. In general, the circuitry that forms the structure corresponding to “configured to” may include hardware circuits. The hardware circuits may include any combination of combinatorial logic circuitry, clocked storage devices such as flops, registers, latches, etc., finite state machines, memory such as static random access memory or embedded dynamic random access memory, custom designed circuitry, analog circuitry, programmable logic arrays, etc. Similarly, various units/circuits/components may be described as performing a task or tasks, for convenience in the description. Such descriptions should be interpreted as including the phrase “configured to.”

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims a unit/circuit/component or other structure that is configured to perform one or more tasks is expressly intended not to invoke 35 U.S.C. § 112(f) interpretation for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In an embodiment, hardware circuits in accordance with this disclosure may be implemented by coding the description of the circuit in a hardware description language (HDL) such as Verilog or VHDL. The HDL description may be synthesized against a library of cells designed for a given integrated circuit fabrication technology, and may be modified for timing, power, and other reasons to result in a final design database that may be transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and may further include other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA.

As used herein, the term “based on” or “dependent on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

### DETAILED DESCRIPTION OF EMBODIMENTS

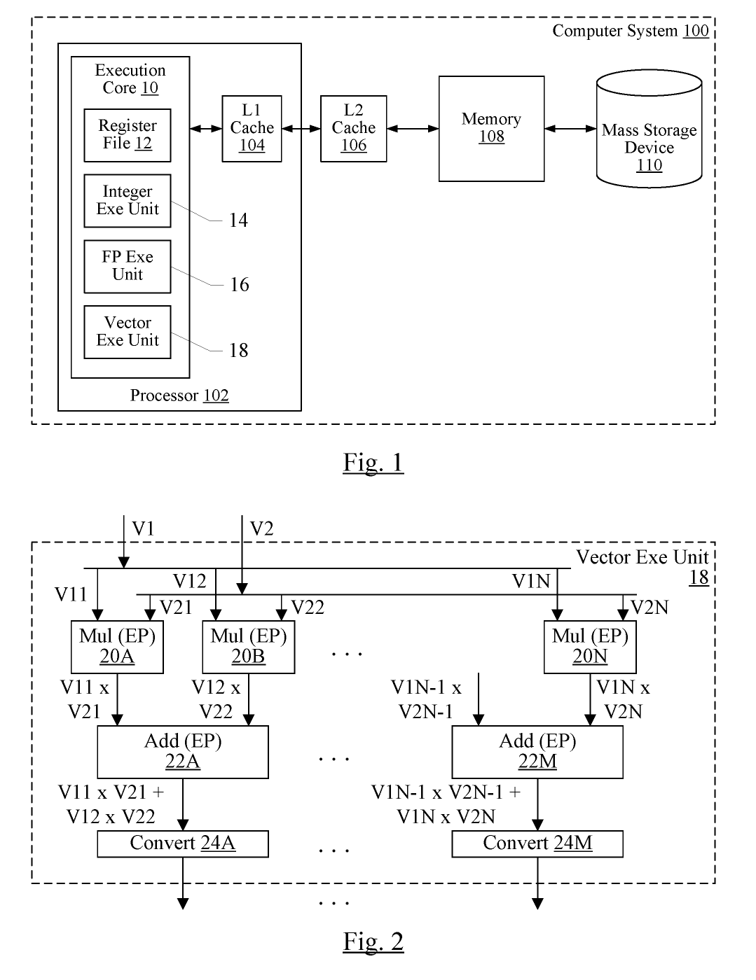

Turning now to FIG. 1, a block diagram of one embodiment of a computer system is shown. Computer system 100 includes a processor 102, a level two (L2) cache 106, a memory 108, and a mass-storage device 110. As shown, processor 102 includes a level one (L1) cache 104 and an execution core 10 coupled to the L1 cache 104. The execution core 10 includes a register file 12 and may include one or more execution units such as integer execution unit 14, floating point (FP) execution unit 16, and vector execution unit 18 as shown. The execution units 14, 16, and 18 may be coupled to the register file 12, and/or there may be multiple register files 12 for different operand types, in various embodiments. It is noted that although specific components are shown and described in computer system 100, in alternative embodiments different components and numbers of components may be present in computer system 100. For example, computer system 100 may not include some of the memory hierarchy (e.g., L2 cache 104, memory 108 and/or mass-storage device 110). Multiple processors similar to the processor 102 may be included. Multiple execution units of a given type (e.g. integer, floating point, vector, load/store, etc.) may be included and the number of execution units of a given type may differ from the number of execution units of another type. Additionally, although the L2 cache 106 is shown external to the processor 102, it is contemplated that in other embodiments, the L2 cache 106 may be internal to the processor 102. It is further noted that in such embodiments, a level three (L3) cache (not shown) may be used. In addition, the computer system 100 may include graphics processors, video cards, video-capture devices, user-interface devices, network cards, optical drives, and/or other peripheral devices that are coupled to processor 102 using a bus, a network, or another suitable communication channel (all not shown for simplicity).

In various embodiments, the processor 102 may be representative of a general-purpose processor that performs computational operations. For example, the processor 102 may be a central processing unit (CPU) such as a microprocessor, a microcontroller, an application-specific integrated circuit (ASIC), or a field-programmable gate array (FPGA). The processor 102 may be a standalone component, or may be integrated onto an integrated circuit with other components (e.g. other processors, or other components in a system on a chip (SOC), etc.). The processor 102 may be a component in a multichip module (MCM) with other components.

More particularly, as illustrated in FIG. 1, the processor 102 may include the execution core 10. The execution core 10 may be configured to execute instructions defined in an instruction set architecture implemented by the processor 102. The execution core 10 may have any microarchitectural features and implementation features, as desired. For example, the execution core 10 may include superscalar or scalar implementations. The execution core 10 may include in-order or out-of-order implementations, and speculative or non-speculative implementations. The execution core 10 may include any combination of the above features. The implementations may include microcode, in some embodiments. The execution core 10 may include a variety of execution units, each execution unit configured to execute operations of various types (e.g. the integer execution unit 14, the floating point execution unit 16, the vector execution unit 18, a load/store execution unit (not shown) etc.). The execution core 10 may include different numbers pipeline stages and various other performance-enhancing features such as branch prediction. The execution core 10 may include one or more of instruction decode units, schedulers or reservations stations, reorder buffers, memory management units, I/O interfaces, etc.

The register file 12 may include a set of registers that may be used to store operands for various instructions. The register file 12 may include registers of various data types, based on the type of operand the execution core 10 is configured to store in the registers (e.g. integer, floating point, vector, etc.). The register file 12 may include architected registers (i.e. those registers that are specified in the instruction set architecture implemented by the processor 102). Alternatively or in addition, the register file 12 may include physical registers (e.g. if register renaming is implemented in the execution core 10).

The L1 cache 104 may be illustrative of any caching structure. For example, the L1 cache 104 may be implemented as a Harvard architecture (separate instruction cache for instruction fetching by the fetch unit 201 and data cache for data read/write by execution units for memory-referencing ops), as a shared instruction and data cache, etc. In some embodiments, load/store execution units may be provided to execute the memory-referencing ops.

An instruction may be an executable entity defined in an instruction set architecture implemented by the processor 102. There are a variety of instruction set architectures in existence (e.g. the x86 architecture original developed by Intel, ARM from ARM Holdings, Power and PowerPC from IBM/Motorola, etc.). Each instruction is defined in the instruction set architecture, including its coding in memory, its operation, and its effect on registers, memory locations, and/or other processor state. A given implementation of the instruction set architecture may execute each instruction directly, although its form may be altered through decoding and other manipulation in the processor hardware. Another implementation may decode at least some instructions into multiple instruction operations for execution by the execution units in the processor 102.

Some instructions may be microcoded, in some embodiments. Accordingly, the term “instruction operation” may be used herein to refer to an operation that an execution unit in the processor 102/execution core 10 is configured to execute as a single entity. Instructions may have a one to one correspondence with instruction operations, and in some cases an instruction operation may be an instruction (possibly modified in form internal to the processor 102/execution core 10). Instructions may also have a one to more than one (one to many) correspondence with instruction operations. An instruction operation may be more briefly referred to herein as an “op.”

The mass-storage device 110, memory 108, L2 cache 10, and L1 cache 104 are storage devices that collectively form a memory hierarchy that stores data and instructions for processor 102. More particularly, the mass-storage device 110 may be a high-capacity, non-volatile memory, such as a disk drive or a large flash memory unit with a long access time, while L1 cache 104, L2 cache 106, and memory 108 may be smaller, with shorter access times. These faster semiconductor memories store copies of frequently used data. Memory 108 may be representative of a memory device in the dynamic random access memory (DRAM) family of memory devices. The size of memory 108 is typically larger than L1 cache 104 and L2 cache 106, whereas L1 cache 104 and L2 cache 106 are typically implemented using smaller devices in the static random access memories (SRAM) family of devices. In some embodiments, L2 cache 106, memory 108, and mass-storage device 110 are shared between one or more processors in computer system 100.

In some embodiments, the devices in the memory hierarchy (i.e., L1 cache 104, etc.) can access (i.e., read and/or write) multiple cache lines per cycle. These embodiments may enable more effective processing of memory accesses that occur based on a vector of pointers or array indices to non-contiguous memory addresses.

It is noted the data structures and program instructions (i.e., code) described below may be stored on a non-transitory computer-readable storage device, which may be any device or storage medium that can store code and/or data for use by a computer system (e.g., computer system 100). Generally speaking, a non-transitory computer-readable storage device includes, but is not limited to, volatile memory, non-volatile memory, magnetic and optical storage devices such as disk drives, magnetic tape, compact discs (CDs), digital versatile discs or digital video discs (DVDs), or other media capable of storing computer-readable media now known or later developed. As such, mass-storage device 110, memory 108, L2 cache 10, and L1 cache 104 are all examples of non-transitory computer readable storage media.

As mentioned above, the execution core 10 may be configured to execute vector instructions (e.g. in the vector execution unit 18). The vector instructions may be defined as single instruction-multiple-data (SIMD) instructions in the classical sense, in that they may define the same operation to be performed on multiple data elements in parallel. The data elements operated upon by an instance of an instruction may be referred to as a vector. The data elements forming the vector may be referred to as vector elements. Vector elements themselves may have any data type (e.g. integer, floating point, etc.) and more than one data type may be supported for vector elements.

For floating point vector elements, various precisions may be supported. A lower precision, such as 16 bit, may allow for more vector elements in a given register size. On the other hand, the size of sum that may be accumulated is limited by the low precision. In an embodiment, the execution core 10/vector execution unit 18 may implement an FMA instruction that takes vector operands at a lower precision but performs the multiplication and addition at a higher precision. In an embodiment, the higher precision may be an extended precision, or the highest precision supported by the processor 102. The results may be written to a result register (also referred to as destination register or target register) at a higher precision as well. The result precision may be the precision at which the operations are performed, or may be a precision between the lower precision and the precision at which the operations are performed (e.g. the result precision may be 32 bit, in an embodiment). Because the destination register receives higher precision vector elements, fewer elements may be stored than the source registers of the FMA instruction, in an embodiment. Accordingly, adjacent pairs of multiplication results may be added to produce each result vector element. Additional details will be provided below.

In one embodiment, the register file 12 may include vector registers that can hold operand vectors and result vectors. In some embodiments, there may be 32 vector registers in the vector register file. However, in alternative embodiments, there may be different numbers of vector registers and/or different numbers of bits per register. Furthermore, embodiments which implement register renaming may include any number of physical registers that may be allocated to architected vector registers. Architected registers may be registers that are specifiable as operands in vector instructions.

Turning next to FIG. 2, a block diagram of an embodiment of the vector execution unit 18 is shown in greater detail. In the illustrated embodiment, the vector execution unit 18 includes extended precision multiplier circuits 20A-20N, extended precision adder circuits 22A-22M, and convert circuits 24A-24M. It is noted that the illustration of FIG. 2 is a logical view of the circuitry. In practice, the multiplication and addition circuitry is often fused together to reduce delay in producing the result. The convert circuits 24A-24M may be fused with the multiply-add circuitry as well.

The multiplier circuits 20A-20N are coupled to receive respective vector elements from the source vectors V1 and V2. The various vector components are shown in FIG. 2 as V11 to V1N (for source vector V1) and V21 to V2N (for source vector V2). The source vector components may have a first precision (e.g. a low precision, or the lowest precision supported by the processor 102, in an embodiment). Each vector element of vector V1 is multiplied by a corresponding vector element of vector V2. That is, the elements from the same position within each vector are multiplied. The multiply may be performed in extended precision in the multiplier circuits 20A-20N (a higher precision than the first precision, and the highest precision supported in the processor 102 in an embodiment). Each adder circuit 22A-22M is coupled to a pair of adjacent multiplier circuits 20A-20N. The multiplication results from adjacent element positions within the vectors are added by the adder circuits 22A-22M. Adjacent element positions may be positions that are next to each other in the vector, with no intervening element positions. Thus, vector element positions 1 and 2 are added in adder circuit 22A, and other element positions are added in other adder circuits (shown via ellipses in FIG. 2) up to the adder circuit 22M adding the element positions N−1 and N. Thus, the number of adder circuits 22A-22M may be ½ the number of multiplier circuits 20A-20N, in this embodiment. Each adder circuit 22A-22M may be coupled to a respective convert circuit 24A-24M. The resulting extending precision sums may then be converted to a result precision in the convert circuits 24A-24M. The result precision may be a second precision lower than the extended precision but higher than the first precision of the source vectors. In other embodiments, the result may remain in the extended precision or the multiply-add may be performed in the second precision, and the convert circuits 24A-24M may be eliminated. In an embodiment, the conversion may be truncation of the significand, and the convert circuits 24A-24M may be wires. Other embodiments may use rounding or other mechanisms to convert from extended precision to the second precision.

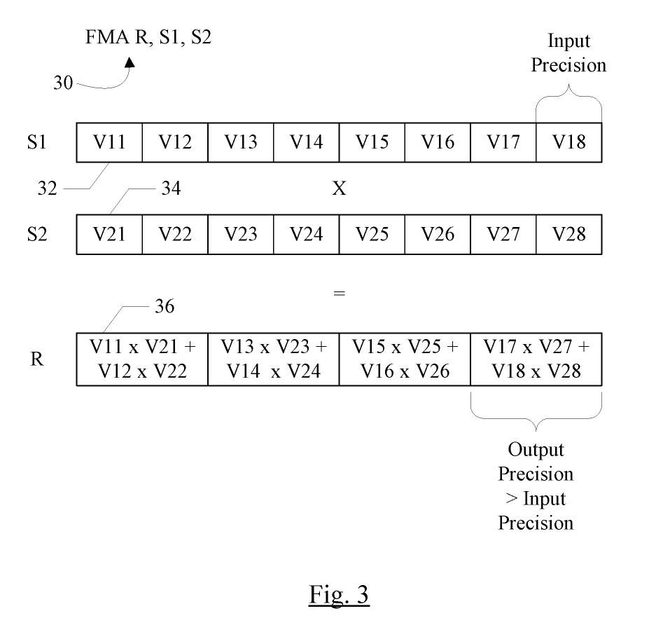

FIG. 3 is a block diagram illustrating an embodiment of the disclosed FMA instruction 30, having source registers S1 and S2 and result register R. The source registers S1 and S2 are shown (reference numerals 32 and 34, respectively), having vector elements V11 to V18 and V21 to V28, respectively, as an example. Other embodiments may have more or fewer vector elements per register at the first precision (or input precision, as illustrated in FIG. 3). The result register 36 is also shown, illustrating sums of adjacent vector element multiplication results at the output precision (which is greater than the input precision as shown in FIG. 3).

While an FMA instruction is illustrated and discussed herein, a fused multiply-subtract instruction is also contemplated and may be implemented in a similar fashion, either using subtract circuits in place of the adder circuits 22A-22M or by modifying the output of the multipliers to invert the sign of the multiplication results. It is noted that, in addition to the FMA instruction described herein, there may be FMA instructions which have the same input and output precision as well.

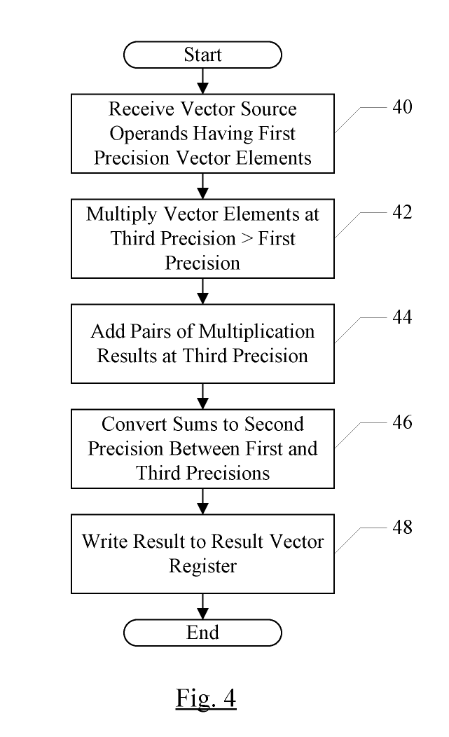

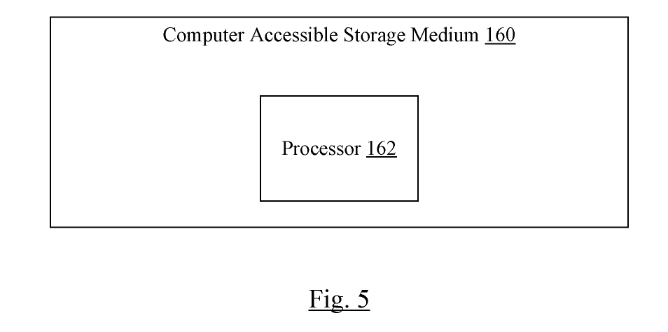

FIG. 4 is a flowchart illustrating operation of one embodiment of the processor 102/execution core 10/vector execution unit 18 in response to an FMA instruction as described herein. While the blocks are shown in a particular order for ease of understanding, other orders may be used. Blocks may be performed in parallel in combinatorial logic in the processor 102/execution core 10/vector execution unit 18. Blocks, combinations of blocks, and/or the flowchart as a whole may be pipelined over multiple clock cycles in the processor 102/execution core 10/vector execution unit 18. Thus, the processor 102/execution core 10/execution unit 18 may be configured to implement the operation illustrated in FIG. 4.

The vector execution unit 18 may receive the vector source operands having vector elements of the first precision (block 40). The vector execution unit 18 may multiply respective vector elements from the vector source operands at a third precision (e.g. extended precision) that is greater than the first precision (block 42) and may sum the adjacent vector elements, also at the third precision (block 44). The vector execution unit 18 may convert the sums to a second precision that is between the first and third precisions (block 46). The vector execution unit 18 may write the resulting vector at the second precision to the result vector register (block 48). As mentioned previously, the blocks 42, 44, and/or 46 may be fused into a more parallel operation, in some embodiments.

FIG. 5 is a block diagram of one embodiment of a computer accessible storage medium 160 storing an electronic description of the processor 102 (reference numeral 162). Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, the computer accessible storage medium 160 may store data in a non-transitory manner, where non-transitory in this context may refer to not transmitting the instructions/data on a signal. For example, non-transitory storage may be volatile (and may lose the stored instructions/data in response to a power down) or non-volatile.

Generally, the electronic description 162 of the processor 102 stored on the computer accessible storage medium 160 may be a database which can be read by a program and used, directly or indirectly, to fabricate the hardware comprising the processor 102. For example, the description may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the processor 102. The netlist may then be placed and routed to produce a data set describing geometric shapes to be applied to masks. The masks may then be used in various semiconductor fabrication steps to produce a semiconductor circuit or circuits corresponding to the processor 102. Alternatively, the description 162 on the computer accessible storage medium 160 may be the netlist (with or without the synthesis library) or the data set, as desired.

While the computer accessible storage medium 160 stores a description 162 of the processor 102, other embodiments may store a description 162 of any portion of the processor 102, as desired (e.g. the vector execution unit 18). The description 162 may be of the processor 102 and other components of the system 100, as well, including up to all of the system 100, in still other embodiments.

Numerous variations and modifications will become apparent to those skilled in the art once the above disclosure is fully appreciated. It is intended that the following claims be interpreted to embrace all such variations and modifications.

What is claimed is:

1. A processor comprising:
a vector execution unit configured to execute a first vector instruction operation that specifies a first vector source operand and a second vector source operand, wherein:
the first vector source operand and the second vector source operand have a first precision;
the vector execution unit is configured to perform a multiply-add operation on the first source vector operand and the second source vector operand at a second precision greater than the first precision;
the multiply-add operation includes multiplying respective vector elements of the first vector operand and the second vector operand and adding multiplication results from adjacent vector element positions at the second precision to generate result vector elements; and
the vector execution unit generating a result vector with the result vector elements at a third precision that is greater than the first precision.

2. The processor as recited in claim 1 wherein the second precision is equal to the third precision.

3. The processor as recited in claim 1 wherein the second precision is greater than the third precision.

4. The processor as recited in claim 3 wherein the vector execution unit is configured to convert the result vector elements from the second precision to the third precision.

5. The processor as recited in claim 4 wherein the vector execution unit converting the result vector elements includes a truncation of a significand in the result vector elements.

6. The processor as recited in claim 1 wherein the first precision is a lowest precision supported by the processor.

7. The processor as recited in claim 1 wherein the second precision is a highest precision supported by the processor.

8. The processor as recited in claim 1 further comprising a register file, wherein the first vector source operand and the second vector source operand are sourced from registers in the register file.

9. The processor as recited in claim 8 wherein the vector execution unit is configured to write the result vector to a register in the register file.

10. A processor comprising:
a vector execution unit configured to execute a first vector floating point instruction operation that specifies a first vector source operand and a second vector source operand, wherein:
the first vector source operand and the second vector source operand are single precision floating point vectors;
the vector execution unit is configured to perform a multiply-add operation on the first source vector operand and the second source vector operand at an extended precision;
the multiply-add operation includes multiplying respective vector elements of the first vector operand and the second vector operand and adding multiplication results from adjacent vector element positions at the extended precision to generate result vector elements; and
the vector execution unit generating a result vector with the result vector elements at a double precision.

11. The processor as recited in claim 10 wherein the vector execution unit is configured to convert the result vector elements from the extended precision to the double precision.

12. The processor as recited in claim 11 wherein the vector execution unit converting the result vector elements includes a truncation of a significand in the result vector elements.

13. The processor as recited in claim 10 wherein the single precision is a lowest precision supported by the processor.

14. The processor as recited in claim 10 wherein the extended precision is a highest precision supported by the processor.

15. A processor comprising:
a vector execution unit configured to execute a first vector floating point instruction operation that specifies a first vector source operand and a second vector source operand, wherein:
the first vector source operand and the second vector source operand are single precision floating point vectors;
the vector execution unit is configured to perform a multiply-add operation on the first source vector operand and the second source vector operand at an extended precision;
the multiply-add operation includes multiplying respective vector elements of the first vector operand and the second vector operand at the extended precision and adding multiplication results from adjacent vector element positions at the extended precision to generate result vector elements at the extended precision; and
the vector execution unit generating a result vector with the result vector elements at a double precision.

16. The processor as recited in claim 15 wherein the vector execution unit is configured to convert the result vector elements from the extended precision to the double precision.

17. The processor as recited in claim 16 wherein the vector execution unit converting the result vector elements includes a truncation of a significand in the result vector elements.

18. The processor as recited in claim 15 wherein the single precision is a lowest precision supported by the processor.

19. The processor as recited in claim 15 wherein the extended precision is a highest precision supported by the processor.

20. The processor as recited in claim 15 further comprising a register file, wherein the first vector source operand and the second vector source operand are sourced from registers in the register file, and wherein the vector execution unit is configured to write the result vector to a register in the register file.
